(19) United States
(12) Patent Application Publication
(10) Pub. No.: US 2017/0259485 A1
(43) Pub. Date: Sep. 14, 2017

(54) EXTRUSION DEVICE

(71) Applicant: Hilti Aktiengesellschaft, Schaan (LI)

(72) Inventors: Rainer Strobel-Schmidt, Bad Woerishofen (DE); Christian Hefele, Breitenbrunn (DE); Peter Ostermeier, Diessen (DE); Hans Peter Lederle, Durach (DE)

(21) Appl. No.: 15/607,719

(22) Filed: May 30, 2017

Related U.S. Application Data
(63) Continuation of application No. 12/925,431, filed on Oct. 21, 2010.

(30) Foreign Application Priority Data
Oct. 21, 2009 (DE) DE 102009045891.3

(51) Int. Cl. B29C 47/92; F15B 15/08

(52) U.S. Cl. CPC B29C 47/92; F15B 15/08; B29C 31/02

(57) ABSTRACT

An extrusion device (11) for compound-containing containers (6), including a receiving chamber (12) for the container (6), a piston rod (13) which is displaceable relative to the receiving chamber (12), a motor (21) for moving the piston rod (13), a trigger member (26) for generating a control signal in response to actuation of the trigger member (26), and a control unit (31) for controlling the motor (21) is provided. The control unit (31) has a power module for connecting the motor (21) to a power supply (19), and a separate signal input which is electrically connected to the trigger member (26). The power module connects the motor (21) to the power supply (19) when the corresponding control signal is present at this signal input. A method for controlling such an extrusion device (11) is also provided.

This is a Continuation of U.S. patent application Ser. No. 12/925,431, filed Oct. 21, 2010 and claims the benefit of German Patent Application DE 10 2009 045 891.3, filed Oct. 21, 2009; both applications are hereby incorporated be reference herein.

The present invention relates to an extrusion device for compound-containing containers. The present invention also relates to a control method for use in such an extrusion device.

### BACKGROUND

Such an extrusion device is used for dispensing compounds which are packaged in containers, such as mortar and sealing compounds, at a site of application. The containers include, for example, cartridges having one or more receiving chambers for one or more components of the compound to be dispensed which are provided directly or packaged, e.g. in foil bags, in the receiving chambers of the cartridge. The term “container” further includes foil bags which are filled with one or more components of the compound to be dispensed and which are inserted in a separate receiving body or in a receiving body mounted on the extrusion device.

U.S. Pat. No. 5,921,437 describes an extrusion device for compound-containing containers, having a receiving chamber for the container, a piston rod which is displaceable relative to the receiving chamber, a motor for moving the piston rod, a trigger member for generating a control signal in response to actuation of the trigger member, and a control unit for controlling the motor. When operating the extrusion device, the compound contained in the container is pressurized, for example, by a thrust member acting on the container, and is extruded through an outlet of the container. In order to prevent the compound from continuing to flow after completion of the extrusion operation, the piston rod is moved back at the end of the extrusion operation by an arbitrary distance determined by the control unit. To this end, the user has to set two control variables, which need to be selected such that they match, in particular, the type of container and the ambient conditions.

### SUMMARY OF THE INVENTION

A drawback of the known approach is that the user must make two settings which requires both hands during the extrusion operation. Besides the complicated handling, the known extrusion device does not allow for constant metering during the dispensing of the compound. Moreover, since the trigger member is interposed in the connection between the power source and the motor, it must be sufficiently sturdy to be able to switch the motor power.

It is an object of the present invention to provide an extrusion device for compound-containing containers which has a simple design and is easy to use, and which ensures that the compound to be dispensed may be dispensed in reproducible amounts throughout the extrusion of the cartridge contents.

The present invention provides a control unit having a power module for connecting the motor to a power supply, and a separate signal input which is electrically connected to the trigger member, the power module connecting the motor to the power supply when the corresponding control signal is present at the first signal input.

Since the trigger member is directly connected to the control unit and, therefore, is external to the connection between the power source and the motor, the trigger member must only be supplied with an auxiliary voltage. The control unit includes a control module and, via the trigger member and a separate logic circuit, acts on the power module connecting the motor to the power supply. The trigger member may be correspondingly small and simple in design. The trigger member requires only a small amount of space inside the housing of the extrusion device and is inexpensive to manufacture. Due to the low current, cables of small cross section can be used for the electrical connection between the trigger member and the control unit. Such cables require less space inside the housing of the extrusion device and are inexpensive to purchase.

The trigger member may be, for example, a switch and advantageously is a push button, which may be electromechanical in design. The power source may include a power cord connected to a mains power supply or, advantageously, a rechargeable battery which, also advantageously, can be replaceably attached to a housing of the extrusion device. The motor may be a brush motor or a brushless motor which, depending on the type of current drawn and, possibly, its transformation, may be a DC motor or an AC motor.

Preferably, the trigger member is also a speed regulator, so that the motor speed is adjusted according to the distance traveled by the trigger member during actuation thereof. This allows the user to dispense the compound to be extruded in large amounts at high speed when necessary, or to selectively dispense the compound to be extruded in small amounts, for example for precise applications. To this end, the trigger member is advantageously an electromechanical push button including a potentiometer.

Preferably, a metering adjustment unit is provided for adjusting the amount of compound to be dispensed with each full stroke. This metering adjustment unit is electrically connected to the control unit via a separate signal input. Since the metering adjustment unit is directly connected to the control unit and, therefore, is external to the connection between the power source and the motor, the metering adjustment unit must only be supplied with an auxiliary current. The metering adjustment unit may be correspondingly small and simple in design. Advantageously, the metering adjustment unit is a potentiometer. The metering adjustment unit preferably has a “zero” position, in which actuation of the trigger member does not cause the motor to be connected to the power source, and an “infinity” position, in which actuation of the trigger member causes the compound to be permanently dispensed until the trigger member is released. The metering adjustment unit also allows selection of intermediate positions between the two aforementioned positions, so that the compound to be extruded can be dispensed by the extrusion device in correspondingly defined amounts upon actuation of the trigger member.

Preferably, a position measurement unit is provided for determining the position of the at least one piston rod. This position measurement unit is electrically connected to the control unit via a separate signal input. Since the position measurement unit is directly connected to the control unit and, therefore, is external to the connection between the power source and the motor, the position measurement unit must only be supplied with an auxiliary current. The position measurement unit may be correspondingly small and simple in design. Advantageously, the position measurement unit includes a potentiometer. The position measurement unit allows the position of the at least one piston rod to be determined at any time during the extrusion process.

Preferably, an indicator unit is provided which is electrically connected to the control unit and which generates a user-perceivable signal when a full stroke has been completed. This allows the user to determine how much of the compound to be extruded has already been dispensed and/or how much of the compound to be extruded is still available for further extrusion operations. Advantageously, the indicator unit is electrically connected to the control unit via a separate signal input. Alternatively, the indicator unit may be indirectly connected to the control unit via an electrical component of the extrusion device, such as via the position measurement unit.

Preferably, the indicator unit generates an audible signal which can be easily perceived by the user. Alternatively, or in addition thereto, the indicator unit may include a visually perceptible indicator which may serve as a level indicator.

Preferably, at least one voltage regulator is connected upstream of the control unit to transform the current of the power source, for example, from alternating current to direct current, or to adjust the voltage from the power source to the voltage of the components of the extrusion device. A voltage regulator advantageously limits the voltage from the power source for the control unit. Furthermore, an additional voltage regulator connected upstream of the corresponding components may limit the maximum voltage of the downstream components and may provide additional safety in the event that a pulse width modulation circuit which also acts as a voltage regulator fails. Moreover, advantageously, a voltage-limiting device, preferably an electronic voltage-limiting device, is provided which monitors the maximum voltage within the extrusion device. If the extrusion device is battery-powered, the provision of an upstream voltage regulator makes it possible to use a battery with a voltage higher than the voltage of the components of the extrusion device for which it is designed. In this manner, longer operating times can be achieved for a battery-powered extrusion device and, in the event of a decrease in operating voltage, for example of the battery, which normally would reduce the performance or change the characteristics of the connected motor, a decrease in performance or change in characteristics can be prevented.

The method of the present invention for controlling the extrusion device of the present invention includes the following steps:

Measuring the actuation time of the trigger member via the control unit, and automatically controlling the motor via the control unit to move the at least one piston rod back by a predetermined distance if the actuation time exceeds a predetermined length of time.

Thus, if the at least one piston rod is moved forward or advanced until the pressure in the container reaches a certain level above ambient, the at least one piston rod will automatically be moved back. Due to the backward movement of the at least one piston rod, a clearance is created for the pressurized compound at the end of the container opposite the extrusion outlet, allowing the pressurized compound to expand toward said end, thereby instantly relieving the positive pressure in the container. In this manner, the compound to be extruded is reliably prevented from continuing to flow after completion of the extrusion operation.

The predetermined distance of backward movement is dependent in particular on the geometry of the container and the extrusion behavior of the compound to be extruded.

The predetermined length of time is determined according to the extrusion behavior of the compound to be extruded. Advantageously, the predetermined length of time corresponds to the period during the extrusion process during which the pressure in the container reaches a level which would cause continued flow of the compound to be extruded after completion of the extrusion operation. For a viscous mortar compound, the predetermined length of time is advantageously in the range from 0.8 to 2.0 seconds.

Preferably, the position of the at least one piston rod is determined after the completion of the forward movement, and the distance to be traveled back is adjusted according to the maximum available distance if the maximum available distance is shorter than the predetermined distance of backward movement. This prevents the extrusion device from being damaged, particularly after insertion of a new container, when the at least one piston rod is in its rearmost position with respect to its forward movement. Frequently, the extrusion device has a rear wall portion which bounds the receiving chamber and through which extends the at least one piston rod. Without adjustment of the distance of backward movement, the at least one piston rod could jam with this wall portion, causing damage to the said wall portion and/or to the at least one piston rod. This could result in malfunctions or even in a complete failure of the extrusion device.

Preferably, the amount of compound to be dispensed with each full stroke is adjusted via the metering adjustment unit, and when the trigger member is actuated again, the at least one piston rod is advanced by a distance equal to the sum of the distance resulting from the selected settings and the distance previously traveled back. This allows the curable compound to be dispensed in reproducible amounts throughout the extrusion process.

Preferably, when the trigger member is released before the full stroke is completed and is then actuated again, the at least one piston rod is advanced by a distance no greater than the sum of the remaining residual distance and the distance possibly traveled back. Because of this, the dispensing operation may be interrupted any number of times, the extrusion operation being automatically stopped when the predetermined amount of the compound to be extruded has been reached.

Alternatively, an interruption occurring before the full stroke is completed will cause the dispensing operation to be restarted, the distance possibly traveled back being added and the at least one piston rod being advanced by the distance equal to the sum.

Preferably, after insertion of a container into the receiving chamber of the extrusion device, the actuation time of the trigger member is not measured until the trigger member has been actuated at least twice. At the beginning of the extrusion process, first, a certain amount of the compound to be extruded, which is also referred to as “reject material”, may be dispensed to ensure that the material dispensed at the site of application is of sufficient quality. If a mixing element is provided at the extrusion outlet, the effective dispensing of the compound is first preceded by the filling of this mixing element, which ensures sufficient mixing of, for example, a multi-component compound.

Preferably, if the forward movement of the at least one piston rod is detected to have stopped before a full stroke is completed, the motor is automatically reversed to move the at least one piston rod back by a predetermined distance, thereby preventing overloading of the motor and/or the drive train, and also of the at least one piston rod. For example, the magnitude of the current drawn by the motor may be monitored, and the control unit may cause a reversal when a certain level is exceeded. Alternatively, a stoppage of the forward movement of the at least one piston rod may be detected by a position measurement unit, which, in the event of stoppage, will send a control signal to the control unit.

Preferably, the distance traveled back when the piston rod stops before a full stroke is completed is greater than the distance that is traveled back when the actuation time of the trigger member exceeds a predetermined length of time. In this manner, advantageously, the relatively high positive pressure in the container is relieved.

Preferably, the power module of the control unit connects the motor to the power supply only after a predefined threshold is exceeded while the trigger member is actuated. This provides a safety feature to prevent unintentional operation of the extrusion device. For example, the control unit may measure the distance traveled by the trigger member during its actuation and control the power module to connect the motor to the power supply only after a distance of, for example, 1 mm to 4 mm has been reached. If the trigger member includes a potentiometer, for example, for speed control, the threshold may be defined according to an electrical resistance measured by the control unit.

### BRIEF DESCRIPTION OF THE DRAWINGS

The present invention is explained in greater detail below with reference to an exemplary embodiment. In the drawing,

FIG. 1 is a side view of an extrusion device;

FIG. 2 is a simplified circuit diagram of the extrusion device;

FIG. 3 is a is a diagram schematically illustrating an extrusion operation;

FIG. 4 is a schematic diagram illustrating an extrusion operation in various substeps; and

FIG. 5 is a schematic diagram of an extrusion operation during which the piston rod stops.

In the drawings, like reference numerals are used to indicate like parts throughout the various views.

### DETAILED DESCRIPTION

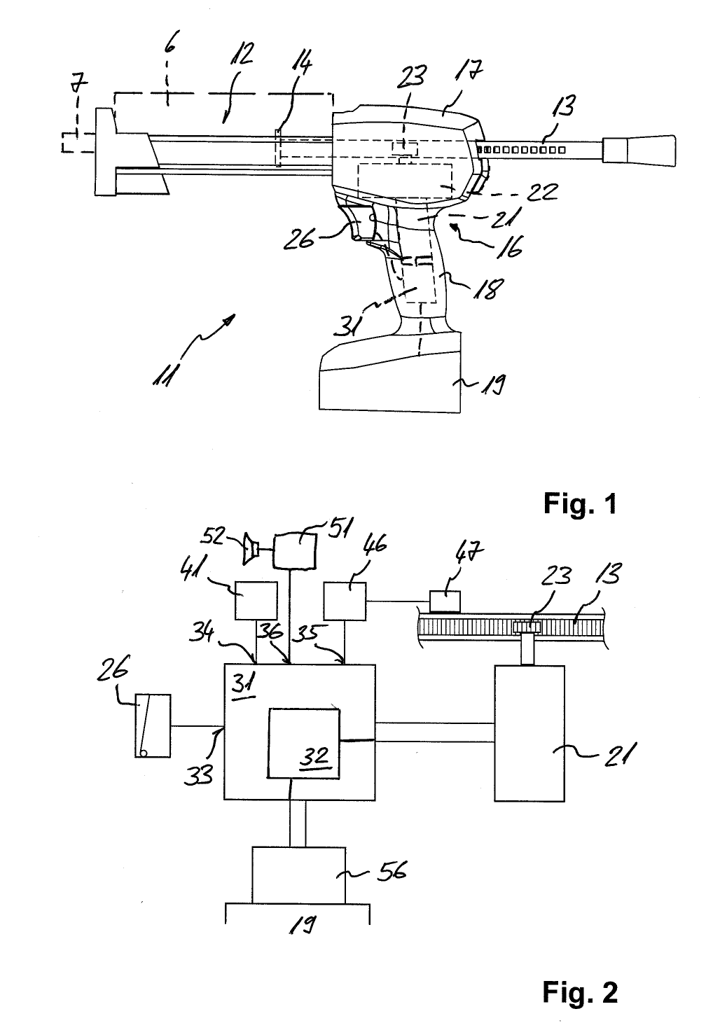

Extrusion device 11 for compound-containing containers 6, as shown in FIG. 1, has a receiving chamber 12 for container 6, a piston rod 13 which is displaceable relative to receiving chamber 12, and an electrically operable extrusion mechanism 16. A pressure piston 14 for applying pressure to container 6 and/or to the compound contained therein is provided on the end of piston rod 13 facing receiving chamber 12. Operation of extrusion mechanism 16 causes piston rod 13 to move into receiving chamber 12, thereby pressurizing the compound contained in container 6, causing it to be extruded through outlet 7 of container 6. The compound contained in container 6 includes one or several components. In the case of a multi-component compound, a mixing element is advantageously provided at outlet 7 of container 6, said mixing element ensuring complete mixing of the components prior to being discharged through the outlet.

Extrusion mechanism 16 is accommodated in a housing 17 having a handle 18 extending therefrom. A power supply 19 in the form of a battery pack is detachably connected to the free end of handle 18. Extrusion mechanism 16 includes a motor 21 which, via a transmission mechanism 22, drives a drive wheel 23 meshing with teeth on piston rod 13, thereby moving piston rod 13.

Handle 18 is further provided with a trigger member 26 in the form of a push button for generating a control signal in response to actuation of trigger member 26. Also provided is a control unit 31 for controlling motor 21, said control unit having a power module 32 for connecting 21 motor to power supply 19, and further having a plurality of signal inputs 33, 34, 35, 36.

As shown schematically in FIG. 2, trigger member 26 is electrically connected to control unit 31 via a first signal input 33. Trigger member 26 includes a potentiometer which, in addition to serving as an ON/OFF switch, is also a speed regulator.

Furthermore, a metering adjustment unit 41 is provided for adjusting the amount of compound to be dispensed with each full stroke. This metering adjustment unit is electrically connected to control unit 31 via a second signal input 34. Metering adjustment unit 41 includes a potentiometer and provides a plurality of possible settings for the dispensing of correspondingly defined amounts of the compound to be extruded, including a “zero” position, in which actuation of trigger member 26 does not cause motor 21 to be connected to power source 19, and an “infinity” position, in which motor 21 is connected to power source 19 for as long as trigger member 26 is actuated.

Also provided is a position measurement unit 46 for determining the position of piston rod 13. This position measurement unit includes a sensor 47 disposed next to piston rod 13 and is electrically connected to control unit 31 via a third signal input 35.

Moreover, an indicator unit 51 is provided which is electrically connected to control unit 31 via a fourth signal input 36 and which generates a user-perceivable signal when a full stroke has been completed. Indicator unit 51 includes a speaker 52 for generating an audible signal.

A voltage regulator 56 is connected upstream of control unit 31, said voltage regulator transforming the voltage of power source 19 to the voltage required to energize motor 21. Alternatively, or in addition to, one or more voltage regulators 56, there is advantageously provided an electronic voltage-limiting device.

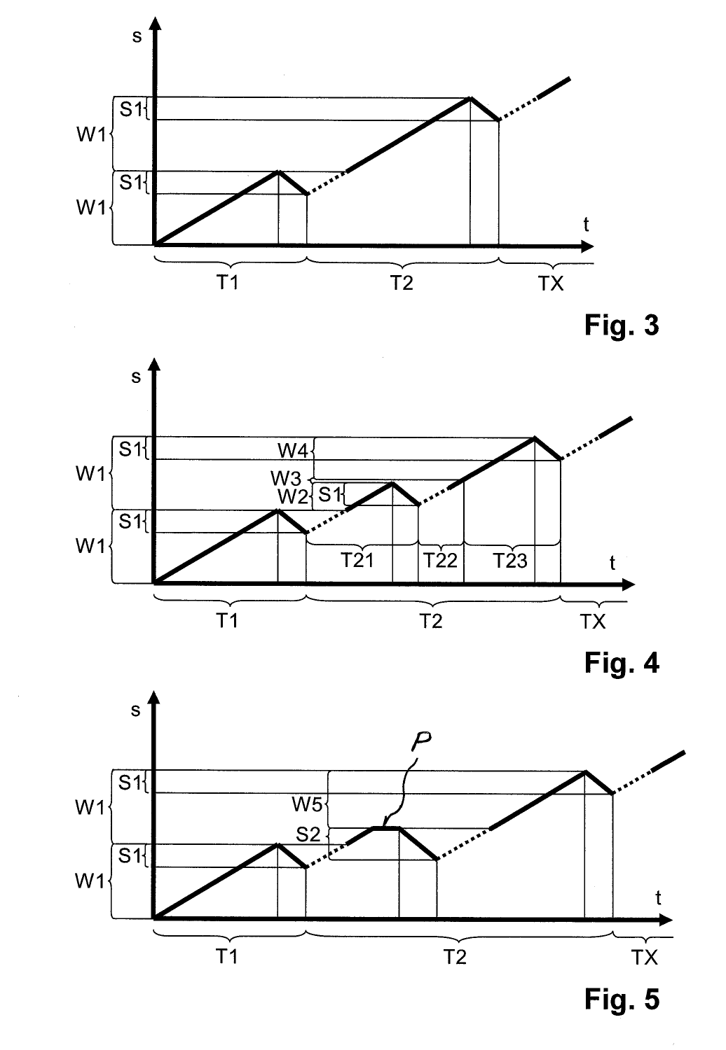

The method for controlling extrusion device 11 will now be described with reference to FIGS. 3 through 5. In the various views, time t is plotted on the abscissa, and the distance traveled by piston rod 13 is plotted on ordinate s.

After insertion of a new or partially used container 6 into receiving chamber 12 of extrusion device 11, a certain amount of the compound to be extruded is dispensed before the actual dispensing operation is performed at the site of application. This initially dispensed amount or reject material of the compound to be extruded serves in particular to fill outlet 7 and, possibly, a mixing element located therein.

In order to dispense the reject material, metering adjustment unit 41 is advantageously set to the “infinity” position, and trigger member 26 is actuated until the quality of the dispensed compound meets the desired requirements. Usually, two or three successive advances of piston rod 13 are sufficient for this purpose.

Alternatively, metering adjustment unit 41 is set to the desired metering settings at the very beginning, and the reject material is dispensed with two to four strokes of extrusion device 11.

If the reject material is dispensed while metering adjustment unit 41 is in the “infinity” position, the amount of compound to be dispensed with each full stroke is subsequently selected using metering adjustment unit 41. Based on the known dimensions of the container and the known properties of the compound to be extruded, control unit 31 uses the selected settings to determine the distance W1 by which piston rod 13 must be advanced. Upon actuation of trigger element 26, the trigger element sends a control signal to control unit 31, whereupon power module 32 connects motor 21 to power source 19. Drive wheel 23 meshing with teeth on piston rod 13 is driven by the output shaft of motor 21 via the transmission mechanism, whereupon piston rod 13 is advanced by distance W1 (see FIG. 3). Power module 32 of control unit 31 connects motor 21 to power supply 19 only after a predefined threshold is exceeded while trigger member 26 is actuated.

In this example, the actuation time of trigger member 26, which corresponds to the period of time during which trigger member 26 is held depressed, is measured by control unit 31 only after the reject material has been dispensed. When the actuation time of trigger member 26 exceeds a predetermined length of time, of, for example, one second, motor 21 is automatically reversed when distance W1 is reached so as to move piston rod 13 back by a defined distance of backward movement S1. In the process, the positive pressure built up in container 6 is relieved, and the compound to be extruded is prevented from continuing to flow out of outlet 7 after completion of this extrusion operation.

When trigger member 26 is actuated again, piston rod 13 is advanced by a distance equal to the sum of the distance W1 resulting from the selected settings and the distance S1 previously traveled back. In this manner, the compound to be extruded is dispensed in an amount that corresponds to the selected setting although piston rod 13 was previously moved back.

The aforementioned steps are repeated until the desired total quantity of the compound to be extruded has been dispensed.

The position of piston rod 13 is determined by position measurement unit 46 after the completion of each forward movement. If piston rod 13 was pulled all the way back, for example, to allow insertion of a new container 6 into receiving chamber 12 of extrusion device 11, and if piston rod 13 was advanced by only a small distance upon actuation of trigger member 26, then the distance to be traveled back is adjusted by control unit 31 according to the maximum available distance if the maximum available distance is shorter than the predetermined distance of backward movement S1. This prevents piston rod 13, and especially thrust member 14, from jamming with, or biasing against, housing 17.

Referring to FIG. 4, first extrusion operation T1 is completed, and the subsequent second extrusion operation T2 is interrupted by the user, for example, by releasing trigger member 26, after piston rod 13 has traveled a distance equal to the sum of the distance S1 previously traveled back and W2 and before the full stroke is completed. Thus, a partial extrusion operation T21 was performed, which is only a fraction of the total extrusion operation T2.

Since during partial extrusion operation T21, trigger member 26 was actuated for a period of time greater than the predetermined length of time, piston rod 13 is moved back by predetermined distance S1.

Trigger member 26 is actuated again, and piston rod 13 is advanced by a distance equal to the sum of distance S1 previously traveled back and W3, and it is then that the user releases trigger member 26 again. Thus, a partial extrusion operation T22 was performed, which is only a fraction of the total extrusion operation T2. Since in this case, the actuation time of trigger member 26 was less than the predetermined length of time, there is not need to relieve the container, and thus, piston rod 13 is not automatically moved back.

When trigger member 26 is actuated once again, piston rod 13 is advanced by only the remaining distance W4, after which the full distance W1 defined by the setting of metering adjustment unit 41 has been traveled by piston rod 13 in the course of extrusion operation T2, and thus, the desired amount of the compound to be extruded has been dispensed. Since during partial extrusion operation T23, trigger member 26 was actuated for a period of time greater than the predetermined length of time, piston rod 13 is automatically moved back by predetermined distance S1 again.

Then, another extrusion operation TX is started when trigger member 26 is actuated again. This extrusion operation TX may be completed in one step, such as extrusion operation T1, or in a plurality of substeps, such as extrusion operation T2.

In FIG. 5, the control method is illustrated for the case that during an extrusion operation T2, the forward movement of piston rod 13 is detected (e.g. by position measurement unit 46) to have stopped before a full stroke is completed during said second extrusion operation T2 (platform P). Motor 21 is automatically reversed to move piston rod 13 back by a predetermined distance S2. This predetermined distance S2 is greater than the predetermined distance of backward movement S1 that is automatically traveled when the actuation time of trigger member 26 exceeds the predetermined length of time. When trigger member 26 is actuated again, piston rod 13 is then advanced by a distance equal to the sum of the remaining distance W5 and distance of backward movement S2, so that when extrusion operation T2 is completed, the desired amount of the compound to be extruded has been dispensed.

In the various diagrams, the variants of the control method are illustrated using the example of second extrusion operation T2. Of course, these variants of the control method are also performed during the first or one of the subsequent extrusion operations TX when one or more of the aforementioned situations occur.

What is claimed is:

1. A method for controlling an extrusion device, the extrusion device for compound-containing containers, including a receiving chamber for a container; at least one piston rod displaceable relative to the receiving chamber; a motor for moving the at least one piston rod; a trigger member for generating a control signal in response to actuation of the trigger member; and a control unit for controlling the motor, the control unit having a power module for connecting the motor to a power supply, and a separate signal input electrically connected to the trigger member, the power module connecting the motor to the power supply when the control signal is present at the signal input, the method, comprising the following steps:
a) measuring the actuation time of the trigger member via the control unit; and
b) automatically controlling the motor via the control unit to move the at least one piston rod back by a predetermined distance if the actuation time exceeds a predetermined length of time;
wherein the position of the at least one piston rod is determined after the completion of the forward movement, a maximum available distance being shorter than the predetermined distance in some instances, and the distance to be traveled back is adjusted according to the maximum available distance when the maximum available distance is shorter than the predetermined distance of backward movement.

2. The control method as recited in claim 1 wherein the amount of compound to be dispensed with each full stroke is adjusted via a metering adjustment unit, and when the trigger member is actuated again, the at least one piston rod is advanced by a distance equal to a sum of the distance resulting from the selected settings and the distance previously traveled back.

3. The control method as recited in claim 2 wherein when the trigger member is released before the full stroke is completed and is then actuated again, the at least one piston rod being advanced by a distance no greater than the sum of the remaining residual distance and the distance possibly traveled back.

4. The control method as recited in claim 1 wherein when a forward movement of the at least one piston rod is detected to have stopped before a full stroke is completed, the motor is automatically reversed to move the at least one piston rod back by a predetermined distance.

5. The control method as recited in claim 4 wherein the distance traveled back when the piston rod stops before a full stroke is completed is greater than the distance that is traveled back when the actuation time of the trigger member exceeds a predetermined length of time.

6. The control method as recited in claim 1 wherein the power module of the control unit connects the motor to the power supply only after a predefined threshold is exceeded while trigger member is actuated.

7. The control method as recited in claim 1 wherein the extrusion device has a handle provided with the trigger member.

8. The control method as recited in claim 7 wherein the trigger member is a push button.

9. The control method as recited in claim 1 further comprising determining a position of the piston rod via a position measurement unit.

10. The control method as recited in claim 9 wherein the position measurement unit includes a sensor electrically connected to the control unit.

11. The control method as recited in claim 1 further comprising generating an audible signal.

12. A method for controlling an extrusion device, the extrusion device for compound-containing containers, including a receiving chamber for a container; at least one piston rod displaceable relative to the receiving chamber; a motor for moving the at least one piston rod; a trigger member for generating a control signal in response to actuation of the trigger member; and a control unit for controlling the motor, the control unit having a power module for connecting the motor to a power supply, and a separate signal input electrically connected to the trigger member, the power module connecting the motor to the power supply when the control signal is present at the signal input, the method, comprising the following steps:
a) measuring the actuation time of the trigger member via the control unit; and
b) automatically controlling the motor via the control unit to move the at least one piston rod back by a predetermined distance if the actuation time exceeds a predetermined length of time;
wherein the position of the at least one piston rod is determined after the completion of the forward movement, a maximum available distance being compared in the control unit to the predetermined distance, and the distance to be traveled back is adjusted according to the maximum available distance when the maximum available distance is shorter than the predetermined distance of backward movement.

13. The control method as recited in claim 13 wherein the amount of compound to be dispensed with each full stroke is adjusted via a metering adjustment unit, and when the trigger member is actuated again, the at least one piston rod is advanced by a distance equal to a sum of the distance resulting from the selected settings and the distance previously traveled back.

14. The control method as recited in claim 13 wherein when the trigger member is released before the full stroke is completed and is then actuated again, the at least one piston rod being advanced by a distance no greater than the sum of the remaining residual distance and the distance possibly traveled back.

15. The control method as recited in claim 12 wherein when a forward movement of the at least one piston rod is detected to have stopped before a full stroke is completed, the motor is automatically reversed to move the at least one piston rod back by a predetermined distance.

16. The control method as recited in claim 15 wherein the distance traveled back when the piston rod stops before a full stroke is completed is greater than the distance that is traveled back when the actuation time of the trigger member exceeds a predetermined length of time.

17. The control method as recited in claim 12 wherein the power module of the control unit connects the motor to the power supply only after a predefined threshold is exceeded while trigger member is actuated.

18. The control method as recited in claim 12 wherein the extrusion device has a handle provided with the trigger member.

19. The control method as recited in claim 12 further comprising determining a position of the piston rod via a position measurement unit.

20. The control method as recited in claim 19 wherein the position measurement unit includes a sensor electrically connected to the control unit.
